(19) United States
(12) Patent Application Publication
(10) Pub. No.: US 2014/0209825 A1
(43) Pub. Date: Jul. 31, 2014

(54) SYSTEM AND METHOD FOR REMOTE CONTROL AND MONITORING OF A VALVE

(71) Applicant: VEEDIMS, LLC, FORT LAUDERDALE, FL (US)

(72) Inventors: JONATHAN S. FICK, WESTFORD, VT (US); ANDREW P. SARGENT, CHITTENDEN, VT (US); JEFFREY N. SEWARD, FAIRFAX, VT (US)

(21) Appl. No.: 14/167,895

(22) Filed: Jan. 29, 2014

Related U.S. Application Data
(60) Provisional application No. 61/758,190, filed on Jan. 29, 2013.

(51) Int. Cl. F16K 31/02

(52) U.S. Cl. CPC F16K 31/02
USPC 251/129.04; 251/129.05

(57) ABSTRACT

A method for remote control and monitoring of a valve from a remote control/monitoring station comprises the following steps: providing a valve assembly including a valve body and a movable valve member, a mechanical position sensor, a drive motor, and an analog control module controlling the drive motor in response to incoming analog control signals and producing analog output control signals corresponding to the position of the valve member; removing the mechanical position sensor; removing the analog control module; operatively connecting an optical position sensor to the valve member; operatively connecting a digital control module to the drive motor and the optical position sensor controlling the drive motor in response to incoming digital control signals and producing digital output control signals corresponding to the valve member position; and communicating the digital input and output signals between the valve controller and a remote control/monitoring station over an electronic network.

### CROSS-REFERENCE TO RELATED APPLICATIONS

This application claims benefit of U.S. Provisional Application No. 61/758,190, filed Jan. 29, 2013, entitled SYSTEM AND METHOD FOR REMOTE CONTROL AND MONITORING OF A VALVE (Atty. Dkt. No. VLLC-31585). U.S. Patent Application No. 61/758,190 is herein incorporated by reference in its entirety.

### TECHNICAL FIELD

The following disclosure relates to industrial, commercial and consumer automation systems, and in particular, to systems and methods for remote control and monitoring of a valve, especially systems and methods implemented over an electronic network such as the Internet or other computer network.

### BACKGROUND

Existing systems and methods for remote control and monitoring of valves often rely on direct wiring, i.e., providing individual wiring runs between the valve controller and the control/monitoring station for each circuit. Such direct wiring may be relatively difficult and expensive to install, maintain and/or modify, especially in large scale industrial settings (e.g., factories, manufacturing plants, processing plants) or commercial settings (e.g., buildings, vessels, aircraft, vehicles). Further, existing systems and methods for remote control and monitoring of valves often utilize analog signals for communication between the valve controllers and the control/monitoring stations. Such systems and methods may become very complex to design, build and maintain, especially on a large scale.

A need therefore exists, for systems and methods for remote control and monitoring of valves that replace direct wiring between the valve controllers and the control/monitoring stations with a more efficient communications system, for example a network data communication system. A need further exists, for systems and methods for remote control and monitoring of valves that replace analog signals with digital signals for communication between the valve controllers and the control/monitoring stations.

### SUMMARY

In one aspect thereof, a method for remote control and monitoring of a valve from a remote control/monitoring station comprises the following steps: providing a valve assembly including a valve body defining a fluid passageway and a movable valve member selectively movable through a operational range between a OPEN position, wherein fluid can pass through the fluid passageway, and a CLOSED position, wherein fluid cannot pass through the fluid passageway, a mechanical position sensor operatively connected to a valve member for mechanically sensing the position of the valve member within the operational range, a drive motor operatively connected to the valve member for changing the position of the valve member, and an analog control module operatively connected to the drive motor and the mechanical position sensor for controlling the drive motor in response to incoming analog control signals and producing analog output control signals corresponding to the position of the valve member; removing from the valve assembly the mechanical position sensor; removing from the valve assembly the analog control module; operatively connecting an optical position sensor to the valve member to optically sense the position of the valve member within the operational range; operatively connecting a digital control module to the drive motor and the optical position sensor for controlling the drive motor in response to incoming digital control signals and producing digital output control signals corresponding to the position of the valve member; and communicating the digital input control signals and digital output control signals between the valve controller and a remote control/monitoring station over an electronic network.

In another embodiment, the electronic network is an Ethernet communication network.

In another embodiment, the electronic network is the Internet.

In still another embodiment, a plurality of valves disposed on a single network line between the remote control/monitoring station and the valves are remotely controlled.

In still another embodiment, a plurality of valves are disposed on a single network cable between the remote control/monitoring station, and the single network cable supplies both electrical power and data communications to the remotely controlled valves.

### BRIEF DESCRIPTION OF THE DRAWINGS

For a more complete understanding, reference is now made to the following description taken in conjunction with the accompanying Drawings in which:

FIG. 1 shows a valve assembly in accordance with the Prior Art;

FIG. 2 is another view of the Prior Art valve assembly of FIG. 1 (partially disassembled);

FIG. 3 shows components removed from a valve assembly in accordance with the method of the current invention;

FIG. 4 shows the upper portion of an upper valve assembly after removal of selected components in accordance with another aspect of the invention;

FIG. 5 shows components to be added to the partially assembled upper valve assembly of FIG. 4;

FIG. 6 shows the optical position sensor mounted on the upper valve assembly;

FIG. 7 the digital control module mounted on the upper valve assembly;

FIGS. 8a and 8b show the network communication connectors installed on the valve assembly case cover;

FIGS. 9a and 9b show an upper valve assembly connected to an electronic network via a single cable providing both electrical power and data communications from a remote control/monitoring station;

FIG. 10 is another view of the Prior Art valve assembly of FIG. 1; and

FIG. 11 is a view of an upper valve assembly connected to an electronic network in accordance with another embodiment.

### DETAILED DESCRIPTION

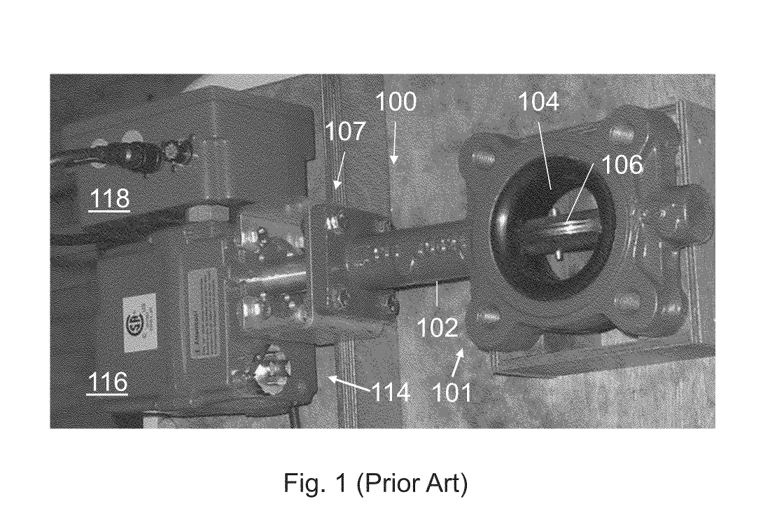

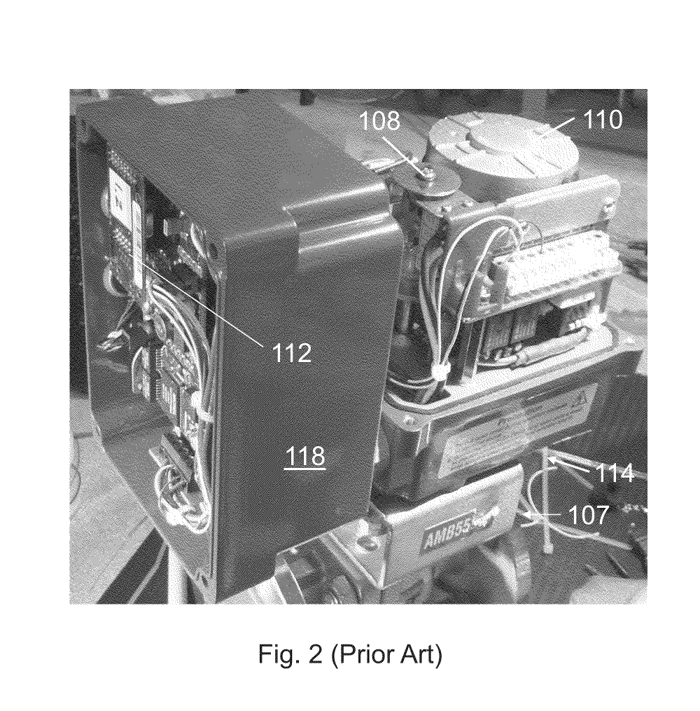

FIGS. 1 and 2 show a valve assembly in accordance with the Prior Art. Specifically, the valve assembly shown in FIGS. 1 and 2 is a 24 volt fluid valve with a version 1 remote control conversion. Such version 1 remote control conversion may be considered “complex and primitive”. The valve assembly 100 includes a lower valve assembly 101 and an upper valve assembly 114. The lower valve assembly 101 includes a valve body 102 defining a fluid passageway 104 and a movable valve member 106 selectively movable through a operational range between a OPEN position, wherein fluid can pass through the fluid passageway, and a CLOSED position, wherein fluid cannot pass through the fluid passageway. The lower valve assembly 101 is operatively connected at base 107 to the upper valve assembly 114. The upper valve assembly 114 is disposed in a case 116 including portions of a remote control assembly, which may further comprise a control box 118 disposed adjacent to the case. The remote control assembly includes a mechanical position sensor 108 operatively connected to the valve member 106 for mechanically sensing the position of the valve member within the operational range. A drive motor 110 is operatively connected to the valve member 106 for changing the position of the valve member, and an analog control module 112 is operatively connected to the drive motor 110 and the mechanical position sensor 108 for controlling the drive motor in response to incoming analog control signals and producing analog output control signals corresponding to the position of the valve member 106. The position sensor 108 and drive motor 110 may be disposed in the upper valve assembly 114, e.g., in the case 116. The analog control module 112 may be disposed in the control box 118.

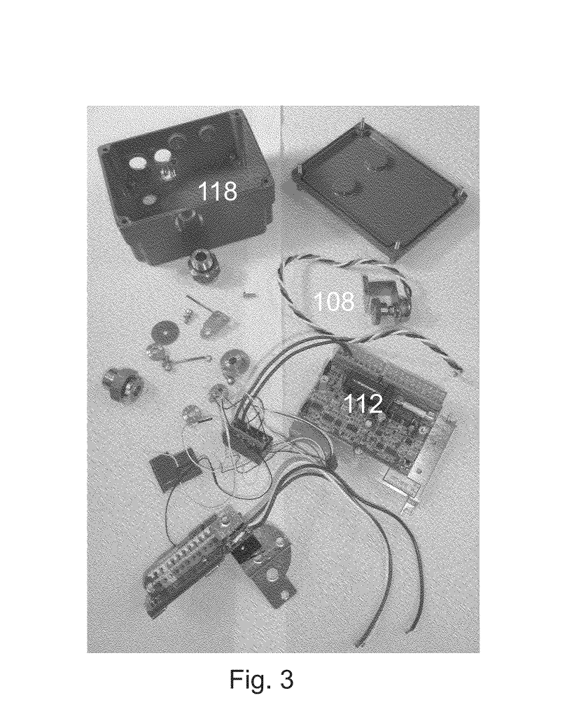

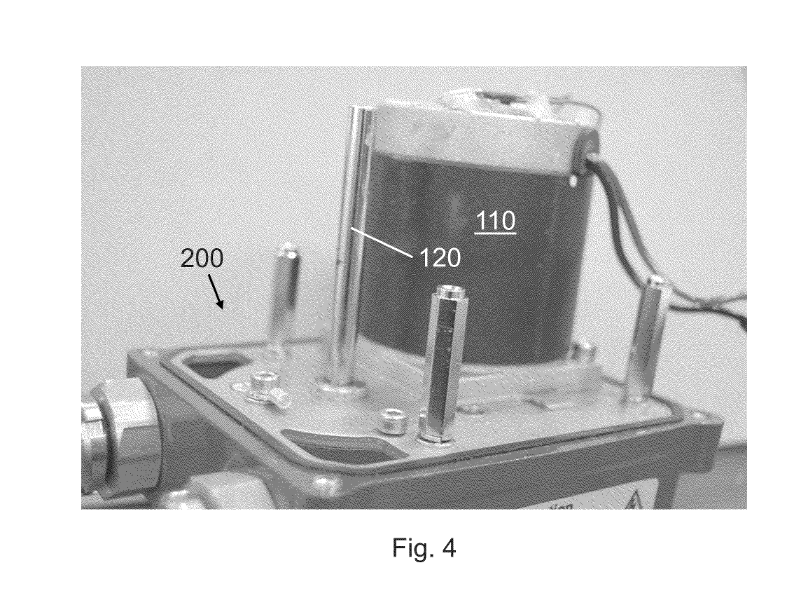

Referring now to FIGS. 3 and 4, in one aspect of the invention, a valve assembly 200 similar to the prior art assembly 100 of FIGS. 1 and 2 is provided. The lower valve assembly of the valve assembly 200 is substantially identical to the lower valve assembly 101 shown in FIG. 1; however, for purposes of illustration, it is not shown in FIGS. 3 and 4. Next, the mechanical position sensor 108 is removed from the valve assembly 200. Next the analog control module 110 is removed. FIG. 3 shows components removed from a valve assembly 200 in accordance with the method of the current invention, namely, the mechanical position sensor 108 and the analog control module 112. If present, the control box 118 may also be removed. All of these components may be removed from the assembly, since they may no longer be necessary with the new controller further described below.

Referring now to FIG. 4, there is illustrated the upper portion 114 of the valve assembly 200 after removal of the mechanical position sensor 108 (FIG. 3) and the analog control module 112 (FIG. 3). In this case, the original valve unit is stripped down to just the electric motor and associated gearbox elements. The drive motor 110 and stem 120 (connected to the valve member 106) are seen.

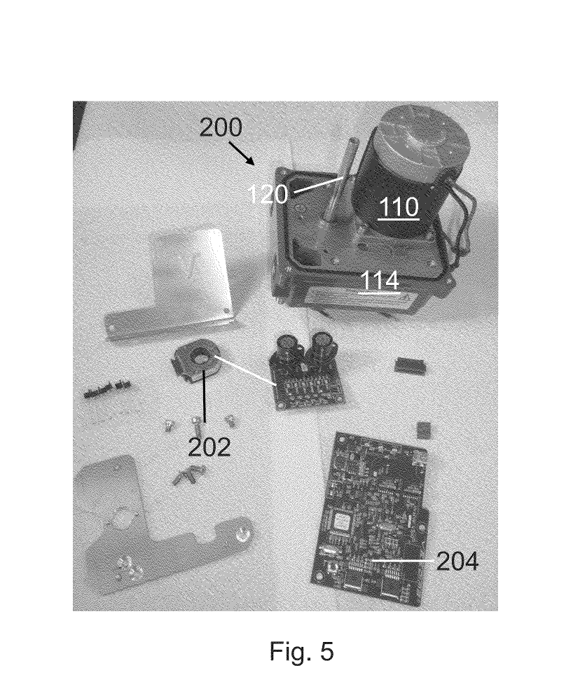

Referring now to FIG. 5, replacement components, namely, mechanical bracketing and printed circuit boards are provided for installation in the valve assembly. Thus, following removal of the mechanical position sensor 108, an optical position sensor 202 is operatively connected to the valve member (e.g., stem 120) to optically sense the position of the valve member 106 within the operational range. Next, a digital control module 204 is operatively connected to the drive motor 110 and the optical position sensor 202 for controlling the drive motor in response to incoming digital control signals and producing digital output control signals corresponding to the position of the valve member 106. FIG. 5 shows the components to be added to the partially assembled upper valve assembly 114 of FIG. 4, namely, the optical position sensor 202 and the digital control module 204. For purposes of illustration, in FIGS. 5, 6, 7, 9a, 9b and 11, the lower valve assembly with the valve body 102, passageway 104 and valve member 106 is removed from the upper valve assembly 114, and thus not shown (though present in the embodiment of the invention).

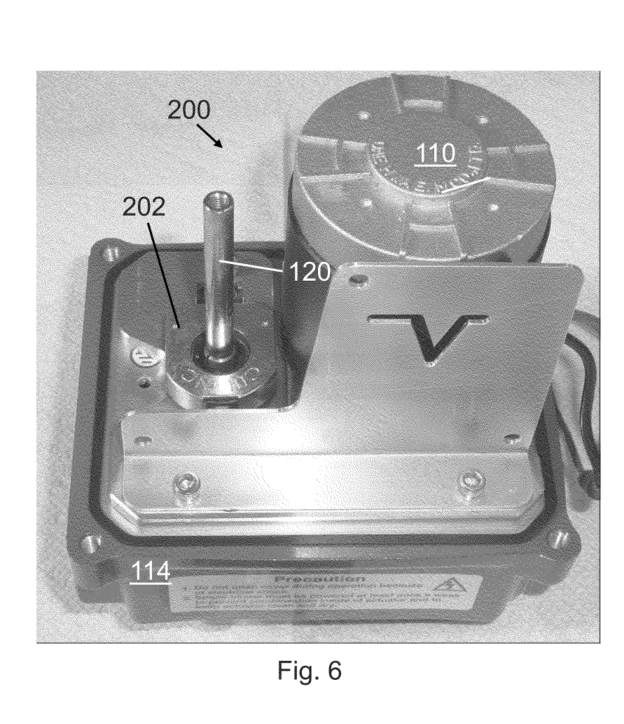

Referring now to FIG. 6, there is illustrated the placement of new mechanical elements in the valve assembly 200. The mechanical elements may include brackets and an optical shaft rotation position sensor. In the embodiment of FIG. 6, the optical position 202 sensor from FIG. 5 is operatively connected to the valve stem 120 on the upper valve assembly 114.

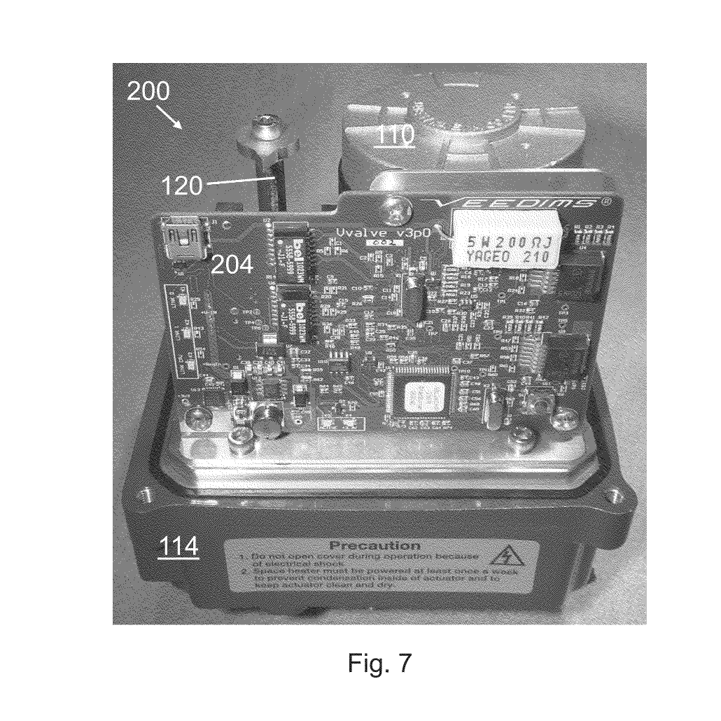

Referring now to FIG. 7, there is illustrated the placement of new circuit boards in the valve assembly 200. The main circuit board may be installed on the upper valve assembly 114. In the embodiment of FIG. 7, the digital control module 202 is mounted on the upper valve assembly 114.

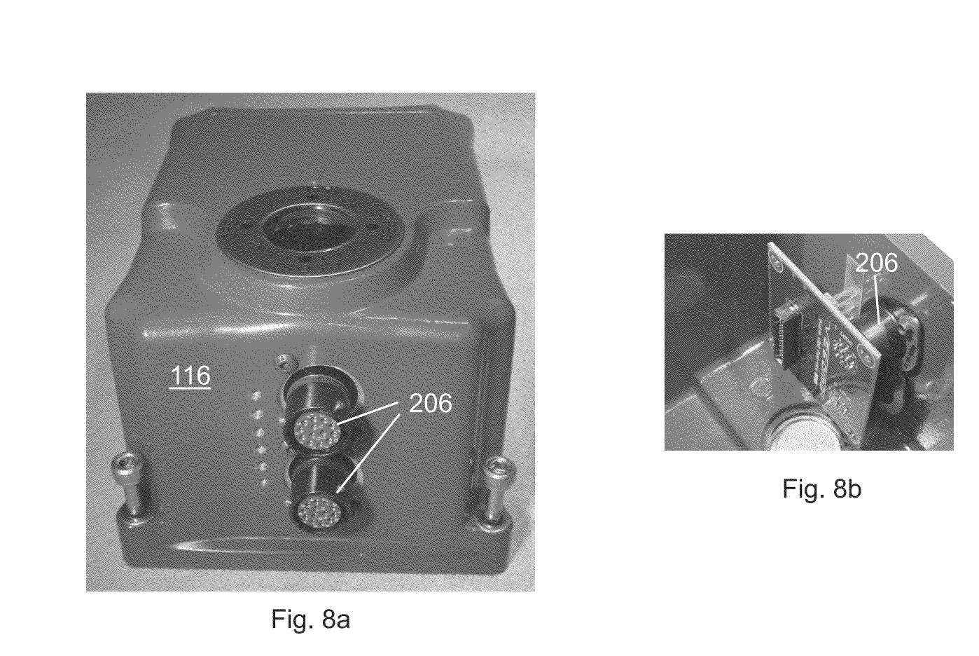

Referring now to FIGS. 8a and 8b, there is illustrated the providing of power/data connectors for the valve assembly 200. In the illustrated embodiment, daisy chain connections 206 are installed in the case cover 116 of the valve assembly 200. FIG. 8a shows the exterior portion of the power/data connectors 206 as seen from the exterior of the case cover 116, and FIG. 8b shows the interior power/data connectors as seen in the interior of the case cover to illustrate the connection to an interface board. The digital control module 204 (FIG. 7) may be operatively connected to the drive motor 110 and the optical position sensor 202 for controlling the drive motor in response to incoming digital control signals and producing digital output control signals corresponding to the position of the valve member 106 (e.g., FIG. 1). The digital input control signals and digital output control signals may be communicated between the valve controller and a remote control/monitoring station over an electronic network. The digital input control signals and digital output control signals may be transmitted through the case cover 116 via the communication connectors 206. FIGS. 8a and 8b show, respectively, exterior and interior views of the network communication connectors 206 installed on the valve assembly case cover 116.

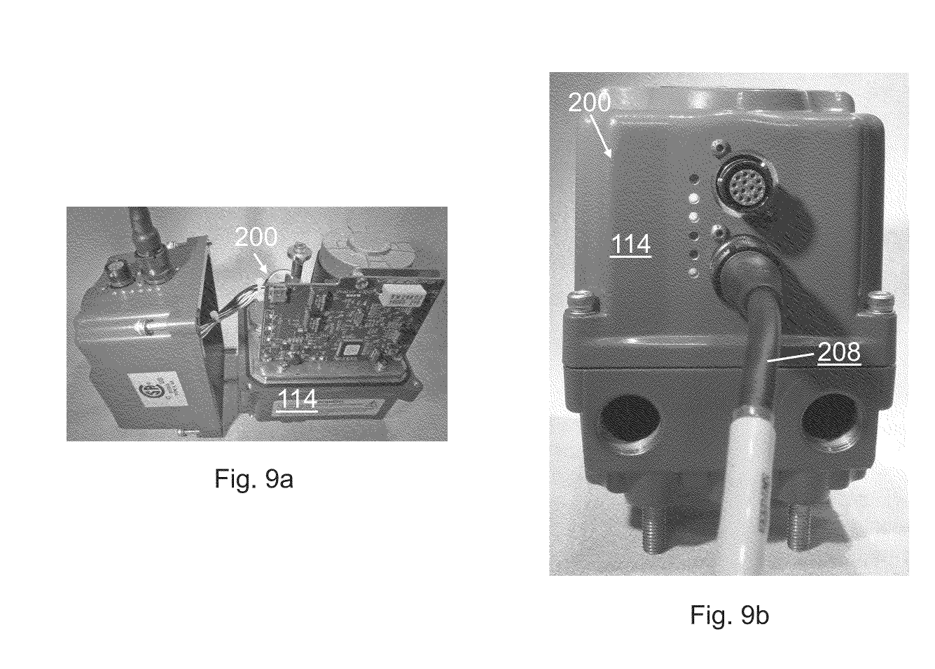

Referring now to FIGS. 9a and 9b, there is illustrated, respectively, open and closed views of an upper valve assembly 114 of a valve assembly 200 connected to an electronic network (not shown) via a single cable 208 providing both electrical power and data communications from a remote control/monitoring station (not shown). The cable 208 is connected to the communication connector 206.

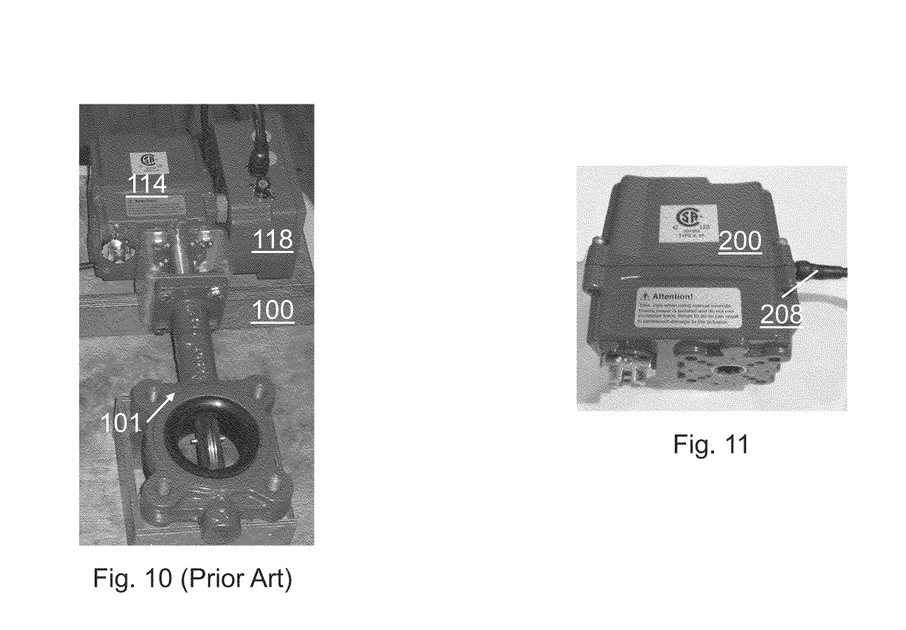

Referring now to FIG. 10, there is shown another view of the Prior Art valve assembly 100 of FIG. 1, showing the lower valve assembly 101 connected to the case 116 (enclosing the upper valve assembly 114) and the control box 118 housing the analog control module 112. This is the configuration of the original remote control valve assembly before conversion to the configuration of the current invention.

Referring now to FIG. 11, there is illustrated the configuration of a remote control valve assembly 200 in accordance with another embodiment. It will be appreciated that FIG. 11 shows just the upper valve assembly 114 portion of the valve assembly, the lower valve assembly 101 portion is not shown for purposes of illustration. It will be further appreciated that valve assembly 200 does not require the control box 118 of the prior art remote control. In one embodiment, the upper valve assembly 114 of the valve assembly 200 is connected to an electronic network. In another embodiment, the electronic network is an Ethernet communication network. In another embodiment, the electronic network is the Internet. In still another embodiment, a plurality of valves 200 disposed on a single network line 208 between the remote control/monitoring station and the valves 200 are remotely controlled.

In still another embodiment, a plurality of 200 valves are disposed on a single network cable 208 between the remote control/monitoring station, and the single network cable supplies both electrical power and data communications to the remotely controlled valves.

Although the preferred embodiment has been described in detail, it should be understood that various changes, substitutions and alterations can be made therein without departing from the spirit and scope of the invention as defined by the appended claims.

What is claimed is:

1. A method for remote control and monitoring of a valve from a remote control/monitoring station, the method comprising the following steps:
providing a valve assembly including a valve body defining a fluid passageway and a movable valve member selectively movable through a operational range between a OPEN position, wherein fluid can pass through the fluid passageway, and a CLOSED position, wherein fluid cannot pass through the fluid passageway, a mechanical position sensor operatively connected to a valve member for mechanically sensing the position of the valve member within the operational range, a drive motor operatively connected to the valve member for changing the position of the valve member, and an analog control module operatively connected to the drive motor and the mechanical position sensor for controlling the drive motor in response to incoming analog control signals and producing analog output control signals corresponding to the position of the valve member;
removing from the valve assembly the mechanical position sensor; removing from the valve assembly the analog control module;
operatively connecting an optical position sensor to the valve member to optically sense the position of the valve member within the operational range;
operatively connecting a digital control module to the drive motor and the optical position sensor for controlling the drive motor in response to incoming digital control signals and producing digital output control signals corresponding to the position of the valve member; and
communicating the digital input control signals and digital output control signals between the valve controller and a remote control/monitoring station over an electronic network.

2. A method in accordance with claim 1, wherein the electronic network is an Ethernet communication network.

3. A method in accordance with claim 1, wherein the electronic network is the Internet.

4. A method in accordance with claim 1, wherein a plurality of valves disposed on a single network line between the remote control/monitoring station and the valves are remotely controlled.

5. A method in accordance with claim 1, wherein a plurality of valves are disposed on a single network cable between the remote control/monitoring station, and the single network cable supplies both electrical power and data communications to the remotely controlled valves.
